(19) United States
(12) Patent Application Publication
(10) Pub. No.: US 2024/0340708 A1
(43) Pub. Date: Oct. 10, 2024

(54) SELF-HEALING NETWORK SLICES USING INTEGRATED MOBILE EDGE COMPUTING AND MULTI CONNECTIVITY

(71) Applicant: AT&T Intellectual Property I, L.P., Atlanta, GA (US)

(72) Inventors: Moshiur Rahman, Marlboro, NJ (US); David H. Lu, Irving, TX (US); Eshrat Huda, Hillsborough, NJ (US)

(73) Assignee: AT&T Intellectual Property I, L.P., Atlanta, GA (US)

(21) Appl. No.: 18/295,606

(22) Filed: Apr. 4, 2023

(51) Int. Cl. H04W 28/24; H04W 28/086; H04W 72/0453

(52) U.S. Cl. CPC H04W 28/24; H04W 28/086; H04W 72/0453

(57) ABSTRACT

Aspects of the subject disclosure may include, for example, identifying a first edge network including a compute resource configured according to a requirement of a network slice to obtain a primary network slice adapted to provide a network service to equipment of a mobile consumer according to a service level requirement. A second edge network at a different location is identified including a first reserve compute resource available for configuration. Remote configuration of the first reserve compute resource is initiated according to the requirement of the network slice to obtain a first backup network slice adapted to provide the network service. Operation of the primary network slice is monitored, and a first performance issue is identified. Responsive to the first performance issue, a providing of the network service is reconfigured from the primary network slice to the first backup network slice. Other embodiments are disclosed.

### FIELD OF THE DISCLOSURE

The subject disclosure relates to a self-healing network slices using integrated mobile edge computing and multi connectivity.

### BACKGROUND

Next Generation mobile networks, such as Fifth Generation New Radio (5G NR) mobile networks, are capable of operating in higher frequency ranges, e.g., in the gigahertz (GHz) frequency band, e.g., with a broad bandwidth near 500-1,000 MHz. The 5G mobile telecommunications standards address operation in millimeter wave bands, e.g., at 14 GHz and higher, which may be utilized to support more reliable, massive machine communications, e.g., machine-to-machine (M2M), Internet of Things (IoT). Next Generation mobile networks, such as those implementing the 5G mobile telecommunications standard, enable a higher utilization capacity than legacy wireless systems, permitting a greater density of wireless users. Next Generation mobile networks are designed to increase data transfer rates, increase spectral efficiency, improve coverage, improve capacity, and reduce latency.

Next Generation Mobile Networks, such as 5G mobile networks, may incorporate features referred to as “Network Slicing.” Network slicing is a type of virtualized networking architecture that involves partitioning of a single physical network into multiple virtual networks. The partitions, or “slices,” of the virtualized network may be customized to meet the specific needs of applications, services, devices, customers, or operators. Each network slice can have its own architecture, provisioning management, and security that supports a particular application or service. Speed, capacity, and connectivity functions are allocated within each network slice to meet the requirements of the objective of the particular network slice. Network slicing may be implemented in a dynamic fashion, such that the slices of the virtualized network may change over time and may be re-customized to meet new or changing needs of applications, services, devices, customers, or operators.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a network slice operation and maintenance (O&M) system functioning within the communication system of FIG. 1 in accordance with various aspects described herein.

FIG. 2B is a block diagram illustrating an example, non-limiting embodiment of a network slice O&M system functioning within the communication system of FIG. 1 in accordance with various aspects described herein.

FIG. 2C is a block diagram illustrating yet another example, non-limiting embodiment of a network slice O&M system functioning within the communication system of FIG. 1 in accordance with various aspects described herein.

FIG. 2D is a block diagram illustrating an example, non-limiting embodiment of a machine learning system functioning within the communication network of FIG. 1 and the network slice O&M system of FIGS. 2A, 2B and/or 2C in accordance with various aspects described herein.

FIG. 2E is a block diagram illustrating another example, non-limiting embodiment of a machine learning system functioning within the communication network of FIG. 1 and the network slice O&M system of FIGS. 2A, 2B and/or 2C in accordance with various aspects described herein.

FIG. 2F depicts an illustrative embodiment of a network slice O&M process in accordance with various aspects described herein.

FIG. 2G depicts an illustrative embodiment of another network slice O&M process in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for identifying multiple, geographically diverse edge network resources able to host a network slice adapted to provide a network service to equipment of a mobile consumer according to a service level requirement. The edge network resources may be arranged according to primary and backup roles in which a backup resource may be preconfigured according to a network slice requirement. Having preconfigured a backup resource this manner, transition from a backup role to a primary role may be performed automatically upon indication of an issue likely to jeopardize delivery of the service according to the service level requirement. In at least some instances the process may be extended by identifying other edge network resources able to host the network slice, possibly including mobile edge network resources that may be deployed and preconfigured in a like manner to serve as a second level of backup. Other embodiments are described in the subject disclosure.

One or more aspects of the subject disclosure include a self-healing network system, that includes a processing system including a processor and a memory that stores executable instructions. The instructions, when executed by the processing system, facilitate performance of operations that include selecting a first edge network at a first physical location corresponding to an edge of a mobile communications network. The first edge network includes a compute resource configured according to a requirement of a network slice to obtain a primary network slice. The primary network slice is adapted to provide a network service to a mobile consumer according to a service level requirement; associating with the network service a second edge network at a second physical location corresponding to the edge of the mobile communications network and geographically separated from the first physical location. The second edge network includes a first reserve compute resource available for configuration; remotely configuring the first reserve compute resource according to the requirement of the network slice to obtain a first backup network slice adapted to provide the network service to equipment of the mobile consumer according to the service level requirement. The primary network slice is monitored to obtain first monitored performance data and a first performance issue of the primary network slice is identified according to the first monitored performance data. A providing of the network service from the primary network slice to the first backup network slice is redirected responsive to the first performance issue.

One or more aspects of the subject disclosure include a self-healing, networking process that includes identifying, by a processing system including a processor, a first edge network at a first physical location corresponding to an edge of a mobile communications network, wherein the first edge network comprises a compute resource configured according to a requirement of a network slice to obtain a primary network slice. The primary network slice is adapted to provide a network service to equipment of a mobile consumer according to a service level requirement. A second edge network is identified by the processing system at a second physical location corresponding to the edge of the mobile communications network. The second physical location is geographically separated from the first physical location. The second edge network includes a first reserve compute resource available for configuration. A remote configuration of the first reserve compute resource is initiated by the processing system according to the requirement of the network slice to obtain a first backup network slice.

The first backup network slice is adapted to provide the network service to the equipment of the mobile consumer according to the service level requirement. Operation of the primary network slice is observed by the processing system to obtain first performance data and a first performance issue of the primary network slice is detected by the processing system according to the first performance data. Responsive to the first performance issue, a providing of the network service is redirected, by the processing system, from the primary network slice to the first backup network slice.

One or more aspects of the subject disclosure include a non-transitory, machine-readable medium, including executable instructions that, when executed by a processing system including a processor, facilitate performance of operations. The operations include identifying a first edge network at a first physical location corresponding to an edge of a mobile communications network, wherein the first edge network comprises a compute resource configured according to a requirement of a network slice to obtain a primary network slice. The primary network slice is adapted to provide a network service to equipment of a mobile consumer according to a service level requirement. A second edge network is identified at a second physical location corresponding to the edge of the mobile communications network and geographically separated from the first physical location. The second edge network includes a first reserve compute resource available for configuration. A remote configuration of the first reserve compute resource is initiated according to the requirement of the network slice to obtain a first backup network slice adapted to provide the network service to the equipment of the mobile consumer according to the service level requirement. Operation of the primary network slice is monitored to obtain first monitored performance data and a first performance issue of the primary network slice is identified according to the first monitored performance data. Responsive to the first performance issue, a providing of the network service is reconfigured from the primary network slice to the first backup network slice.

General trends from hosting applications at physical locations towards cloud solutions. Cloud-based applications or apps and/or streaming services rely on a carrier's network, thus placing more and more responsibility on the carrier for continuous connectivity and reliability. Network performance measures, such as a frequency of network failures, sometimes referred to as a mean time to failure (MTTF) and amount of system downtime are some of the most important factors a communications service provider uses to measure the performance their network.

Telecom networks may adopt a hybrid cloud and/or an open framework architecture to enable greater agility and responsiveness to increased loads and/or exponential growth. In at least some embodiments, networks may be infused with AI, analytics and/or automation to predict and/or preempt outages and/or spikes in demand, and/or to implement adaptations to help prevent interruptions from ever occurring. Beneficially, a network may be automated according to the various disclosed techniques to allow it to effectively self-heal by recognizing a failure and/or predicting that a failure might happen, and then implementing one or more corrective actions to mitigate the failure, in at least some instances, before it even happens.

Analytics may be used to detect changes in the network, while a cognitive component may be adapted to effectively interpret and/or otherwise understands network conditions and in at least some instances, to recommend actions for resolving any issues. Network automation may be adapted to perform any recommended actions to solve a recognized and/or anticipated problem. Such corrective and/or proactive measures may be implemented promptly and seamlessly to preserve delivery of services to network consumers according to service level requirements.

Network slice providing virtualized and independent logical networks serving respective subscribers on common physical network infrastructure. Beneficially, network slices may be deployed and/or otherwise configured provide an end-to-end network that can be tailored to fulfill respective service level requirements (SLR). Network slicing may be enabled, at least in part, by separation of network architectural control elements, e.g., network control interfaces and/or control messages, sometimes referred to as a control plane, from network architectural data transfer elements, e.g., network data interfaces and/or data traffic, sometimes referred to as a user or data plane. Such separate of control and data planes is incorporated into network mobile network standards, such as 5G standards. It is anticipated that similar features will be incorporated into future developments of 5G and later technologies, e.g., 6G, sometimes referred to as beyond 5G, or 5G-beyond (5 GB).

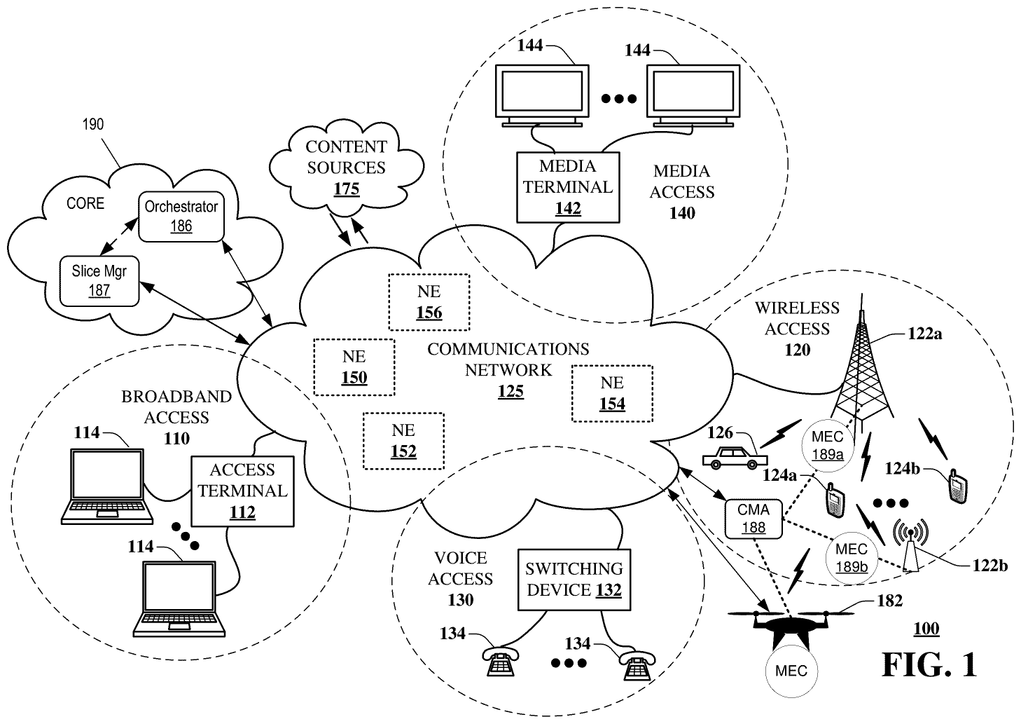

Referring now to FIG. 1, a block diagram is shown illustrating an example, non-limiting embodiment of a communication system 100 in accordance with various aspects described herein. For example, communication system 100 can facilitate in whole or in part identification of multiple, geographically diverse edge network resources configurable to host a network slice adapted to provide a network service to equipment of a mobile consumer according to a service level requirement. The edge network resources may be arranged according to primary and backup roles in which a backup resource may be preconfigured according to a network slice requirement. Having preconfigured a backup resource this manner, transition from a backup role to a primary role may be performed automatically upon indication of an issue likely to jeopardize delivery of the service according to the service level requirement. In at least some instances the process may be extended by identifying other edge network resources able to host the network slice, possibly including mobile edge network resources that may be deployed and preconfigured in a like manner to serve as a second level of backup. In particular, a communications network 125 is presented for providing broadband access 110 to a plurality of data terminals 114 via access terminal 112, wireless access 120 to a plurality of mobile devices 124a, 124b, generally 124, and vehicle 126 via a first base station or access point 122a, a second base station or access point 122b, or some combination of the first and second base stations or access points 122a, 122b, generally 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc., for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access points 122 may include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, gaming systems, remotely operated machinery and/or equipment, robots, vehicles, drones, e.g., including aerial and/or nautical drones, and/or other mobile computing devices. Alternatively, or in addition, the base station or access points 122 may be in communication with other wireless communication capable devices, such as smart homes, smart buildings, and/or other smart infrastructure, e.g., smart roadways, smart appliances, and so on. In at least some embodiments, the base station or access points 122 may support machine type communications, e.g., according to Internet of Things (IoT) applications. It is worth noting here also, that the base station or access points 122 may support virtual, extended and/or augmented reality applications, and/or services as may be engaged in by supporting user equipment and/or devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VOIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc., can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

In at least some embodiments, the wireless access network 120 includes a first multi-access edge computing (MEC) suite 189a in communication with the first base station or access point 122a and a second MEC suite 189b in communication with the second base station or access point 122b. In at least some embodiments, the access network 120 includes a mobile MEC suite 182, e.g., a drone. The MEC suites 189a, 189b, generally 189, may include configurable hardware resources that may be adapted to support one or more compute, storage and/or communication applications. In at least some embodiments in which the wireless access network 120 utilizes network slicing, the MEC suites 189 may be configured to support one or more network slices. It is understood that network slices may be configured and/or otherwise arranged to provide one or more network accessible services to UE of one or more mobile subscribers according to respective service level requirements (SLR). The MEC suites 189 may incorporate one or more features of a cloud computing environment, e.g., providing servers that may be configures and/or reconfigured according to requirements, such as service types, service demands, service requirements, network conditions, and so on. In at least some embodiments, configurable servers may be configured to host one or more virtual machines (VM), e.g., adapted to perform one or more virtual functions (VF) as may be utilized to support a mobile service and/or services.

According to the illustrative embodiment, the communication system 100 may include an orchestration module 186 and a slice manager module 187. The orchestration module 186 may be adapted to support configuration, operation and/or maintenance of a VM, a VF and/or a network slice. For example, the orchestration module 186 may support one or more of automated configuration, coordination, and/or management of one or more aspects of the communication system 100, such as the MEC suites 189 and/or any VMs and/or VFs hosted thereon. According to the various examples provided herein, the MEC suites 189, as well as ay VMs and/or VFs may be configured according to network slicing applications, in which system resources, including resources of the MEC suite 189 may be configured as one or more network slices supporting one or more network service requirements according to their respective SLRs.

The slice manager module 187 that may be in communication with the orchestration module 186 either directly and/or via the communications network 125. The slice manager module 187 may be configured to receive orchestration information, e.g., configuration information and/or requirements for one or more of the wireless access network 120 and/or the MEC suites 189. The orchestration information may include requirements for VMs and/or VFs and/or network slices. The slice manager module 187, in turn, may identify any system resources that may be available and/or otherwise suitable for implementing and/or supporting the orchestration information. System resources may include, without limitation, compute resources, such as remotely configurable servers, cloud servers, and/or other VMs hosted on the configurable servers. In at least some embodiments, the slice manager module 187 may select an available VM, VF and/or network slice that may already be instantiated, have sufficient spare capacity and/or be in a ready state. Alternatively, or in addition, the slice manager module 187 may instantiate a new VM, VF and/or network slice on one or more configurable servers of one or more of the MEC suites 189.

In at least some embodiments, the communication system 100 includes an agent, referred to herein as a common MEC agent (CMA) 188. The CMA 188 may be in communication with one or more of the MEC suites 189. Alternatively, or in addition, the CMA 188 may be in communication with one or more of the orchestration module 186 and/or the slice manager module 187. The CMA 188 may be deployed according to a relatively close proximity as may be compared to a mobile network, core cloud 190 that may host one or more of the orchestration module 186 and/or the slice manager module 187. The relatively close proximity may be determined according to a physical separation, a line-of-sight distance, and/or a transport delay between the MEC suites 189 and the CMA 188. Accordingly, the CMA 188 may be well positioned to obtain timely information from the MEC suites 189 and/or to provide timely instructions to the MEC suites 189, without regard to proximity to other network resources, such as the core cloud 190.

By way of example, the CMA 188 may receive a monitoring requirement from the orchestration module 186. The monitoring requirement may include one or more parameters to be monitored. The parameters may relate to configuration, operation, status and/or performance of the host servers of the MEC suites 189. Alternatively, or in addition, the monitoring requirements may relate to configuration, operation, status and/or performance of any VMs, VFs and/or network slices instantiated upon the host servers of the MEC suites 189. The CMA 188, in turn, may monitor configuration, operation, statues and/or performance of the VMs, VFs, network slices and/or host servers of the MEC suites 189.

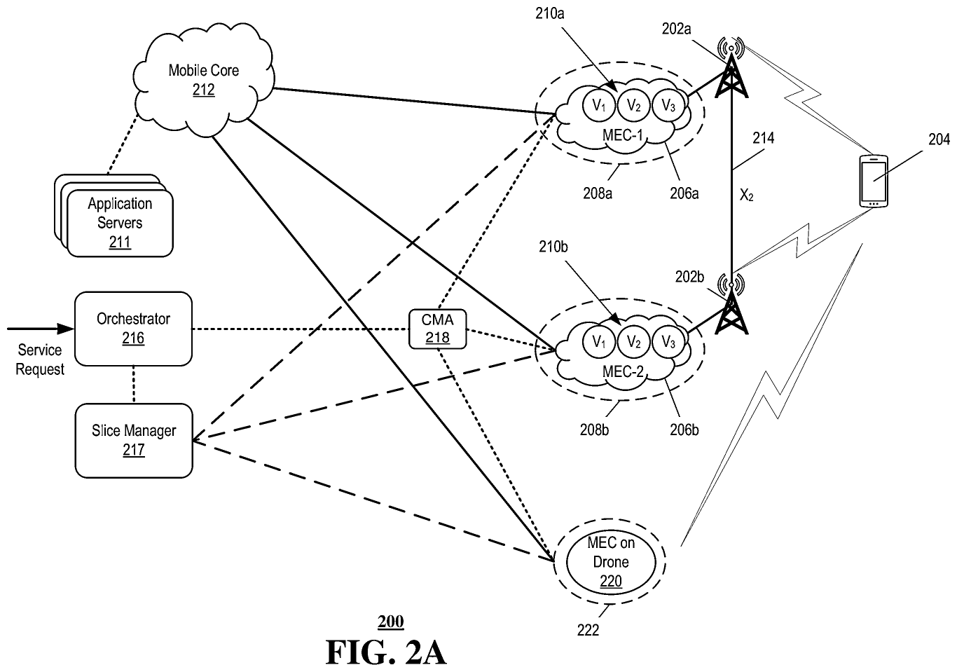

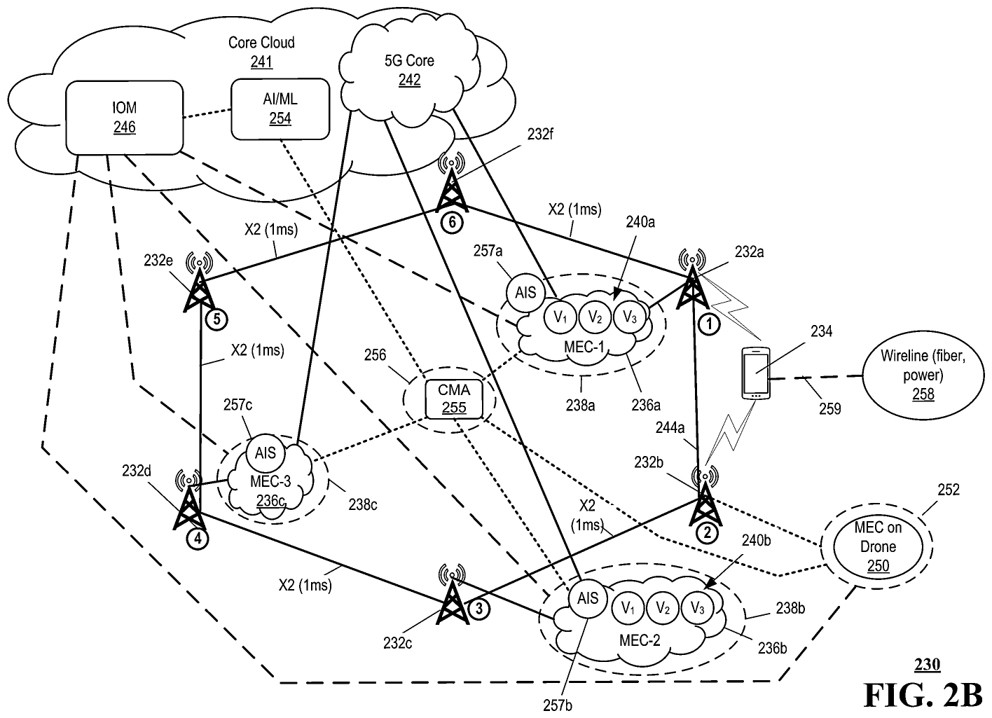

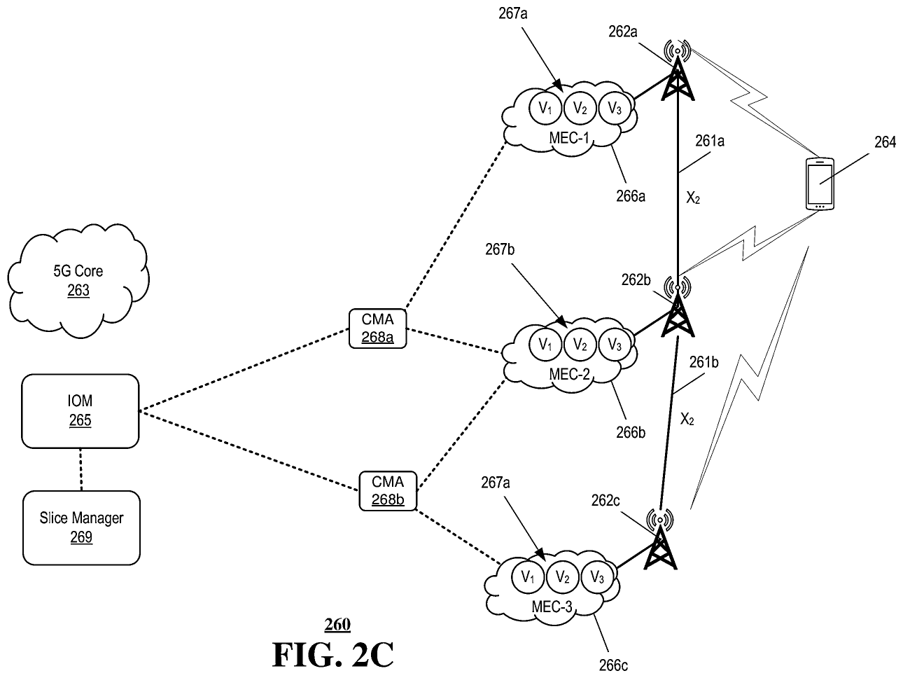

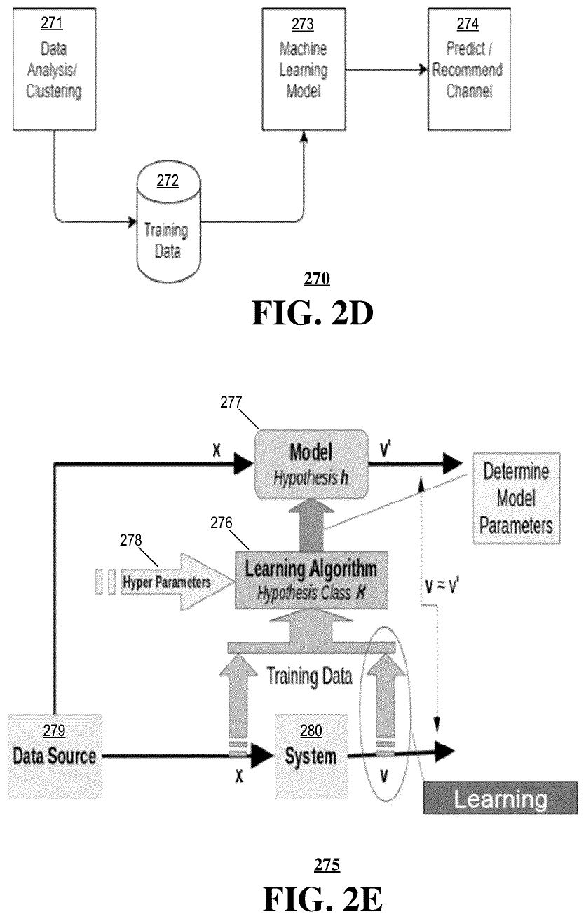

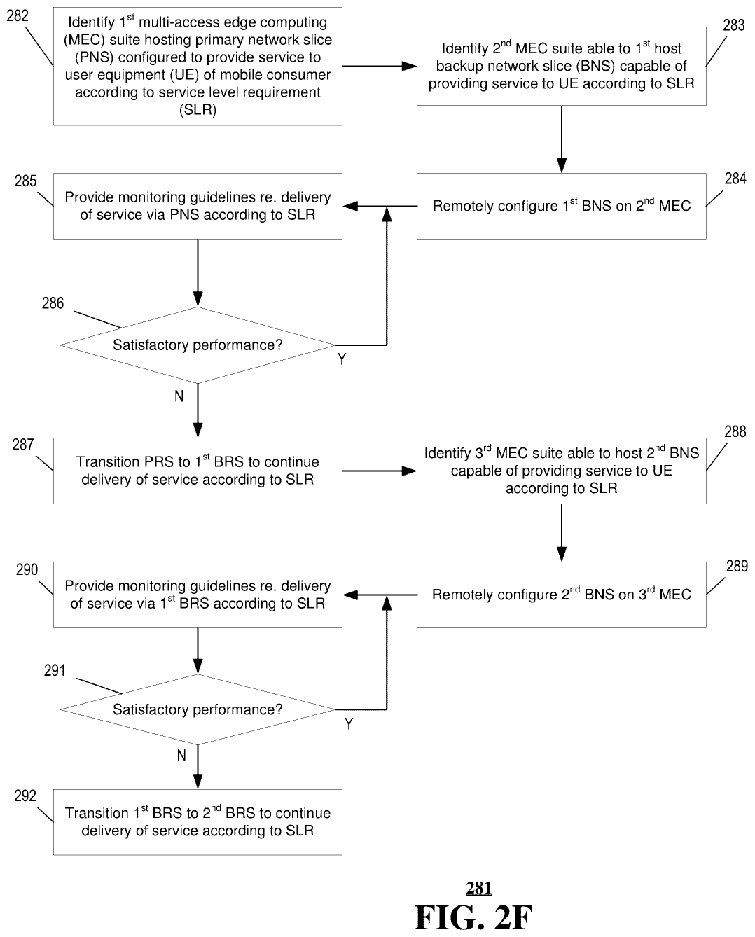

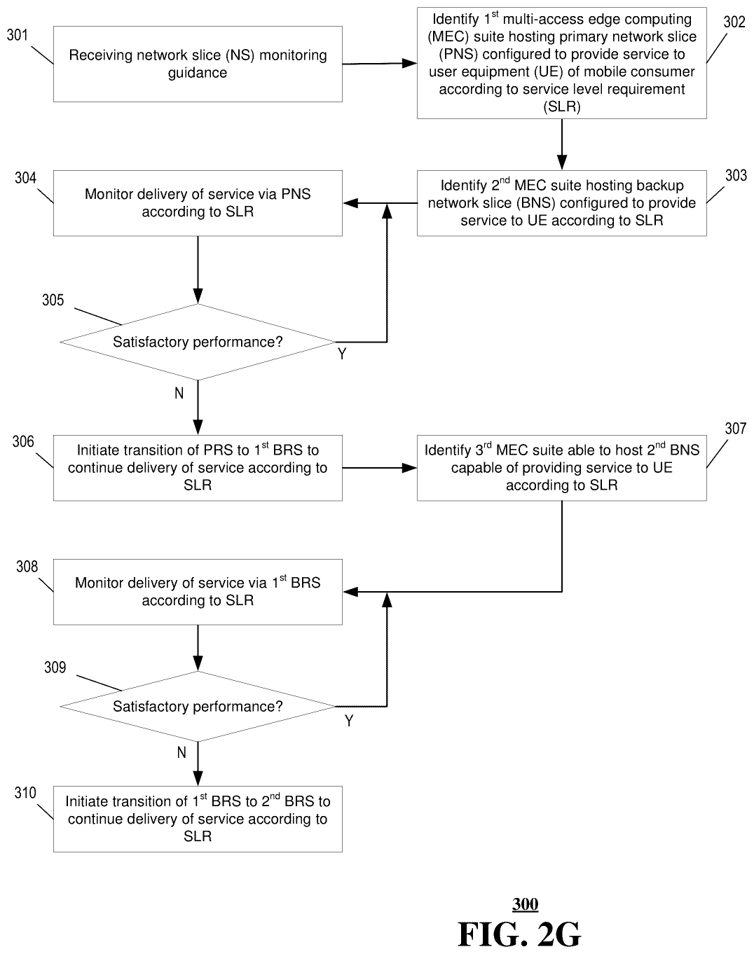

FIG. 2A is a block diagram illustrating an example, non-limiting embodiment of a network slice operation and management (O&M) system 200 functioning within the communication system 100 of FIG. 1 in accordance with various aspects described herein. The example network slice O&M system 200 includes first and second mobile communication transceivers 202a, 202b, generally 202. The mobile communication transceivers may include any of the various cell transceivers, base transceiver stations and/or wireless access points disclosed herein and configured to provide mobile service to a UE 204 of a mobile consumers operating within a supported area of wireless coverage. The example network slice O&M system 200 may include at least one mobile core network 212 adapted to support delivery of mobile services to the UE 204 via the mobile communication transceivers 202. The mobile core network 212 and the mobile communication transceivers 202 may be configured to operate according to one or more mobile communication protocols, including any of the various examples provided herein, such as LTE advanced, New Radio, 5G and/or beyond 5G, e.g., 6G. In at least some embodiments, the mobile core network 212 and mobile communication transceivers 202 are configured to support a separation of control communications, e.g., a control plane, from user data communications, e.g., a user plane.

In at least some embodiments, the mobile core network 212 is in further communication with one or more application servers 211. The application servers 211 may be configured to provide one or more services to UE 204. Services may include virtually any conceivable network accessible services, such as voice, text, web browsing, email, streaming media, navigation, security, data storage and retrieval, self-driving vehicles, and gaming, to name a few. In at least some embodiments, the application servers 211 may include backend servers operated by a network operator or service provider. Alternatively, or in addition, the application servers 211 may be operated by third parties and adapted to provide services to the UE 204 via a wireless access network 120 (FIG. 1).

The example network slice O&M system 200 also incorporates network edge resources in which at least some network resources are deployed at network edge locations. It is envisioned that in at least some embodiments, the network edge locations may be relatively close to mobile communication transceivers 202 and/or the UE 204. Distributing one or more network devices, functions and/or services to a network edge may reduce network congestion and/or responsiveness related to delivery of the mobile services, e.g., by providing local storage and retrieval and/or by reducing network traffic.

In more detail, the example network slice O&M system 200 includes a first MEC suite 206a, represented as a first cloud hosted on a first physical resource suite 208a at a first physical location that may include one or more servers, physical space, physical security, shelter from external environmental conditions, prime power, cooling, data storage, communications, and so on. The example network slice O&M system 200 also includes a second MEC suite 206b, represented as a second cloud hosted on a second physical resource suite 208b at a second physical location that may be remote from the first physical location and also includes one or more servers, physical space, physical security, shelter from external environmental conditions, prime power, cooling, data storage, communications, and so on. Accordingly, the first MEC suite 206a may include a first set of virtual machines (VMs) 210a providing a first set of virtual functions that may support a first group of network slices. Likewise, the second MEC suite 206b may include a second set of virtual machines 210b providing a second set of virtual functions that may support a second group of network slices. The virtual machines 210a, 210b, generally 210, may be configured to deliver one or more mobile services to one or more UE 204 according to one or more respective service level requirements (SLRs).

In at least some embodiments, the example network slice O&M system 200 may include one or more of an orchestration module 216, a slice manager module 217 and a common MEC agent (CMA) 218. The orchestration module 216 may be in communication with the slice manager module 217, which is in further communication with each of the MEC suites 206. Likewise, the CMA 218 may be in communication with each of the MEC suites 201 and in further communication with the orchestration module 216. It is understood that in at least some embodiments, the CMA 218 may be physically located relatively close to the MEC suites 206, at least in comparison to physical locations of the orchestration module 216 and/or the slice manager module 217.

By way of example, the orchestration module 216 may receive a request for one or more services. Requests may be received from one or more of equipment of a network operator, e.g., via the mobile core network 212, an application service provider, e.g., via the application servers 211, and/or the UE 204. In at least some embodiments, the orchestration module 216 may receive a service request from a user, e.g., via an operation and maintenance portal and/or via an expert system that may incorporate one or more of analytics, artificial intelligence (AI) and/or machine learning (ML). Such expert systems may monitor one or more of numbers and/or types of service requests, numbers and/or types of UE 204 associated with service requests, numbers and/or types of active services, historical service records regarding one or more of service delivery statistics, network conditions, and the like.

The orchestration module 216, in turn, may obtain information regarding available resources of one or more MEC suites, their physical locations, network delay and/or latency values, their utilizations, configurations and/or capacities. The orchestration module 216 may be configured to identify required resources at least partly based upon a service request. The orchestration module 216 may be configured to identify available resources of the MEC suites 206 and/or reserved resources of the MEC suites 206 and/or capacity of such resources as may have been preconfigured and/or otherwise instantiated in one or more of the MEC suites 206. The orchestration module 216 may include logic, rules and/or policies to determine whether any of the preconfigured resources may be available to serve the service request. To the extent that such resources are available, the orchestration module 216 may inform the slice manager module 217, which may, in turn, allocate such preconfigured resources to the service request. Alternatively, or in addition, the orchestration module 216 may determine that a new resource should be instantiated and/or otherwise provisioned at one or more of the MEC suites 206. To the extent that one or more of the physical resource suites 208 have sufficient capacity available, e.g., capacity to instantiate a related VM, VF and/or network slice, the slice manager module 271 may initiate such configuration, e.g., via an exchange of instructions between the slice manager module 271 and one or more of the MEC suites 206.

In at least some embodiments, the orchestration module 216 and/or slice manager module 271 may identify a first MEC suite 206a for evaluation in view of a service directed towards the UE 204 via the first mobile communication transceiver 202a. To the extent an orchestration module 216 and/or the slice manager module 217 determine that sufficient resources are available at the first MEC suite 206a, the first MEC suite 206a may be configured to provide any corresponding VMs, VFs and/or network slices. To the extent an orchestration module 216 and/or the slice manager module 217 determine that resources of the first MEC suite 206a are insufficient, the orchestration module 216 and/or the slice manager module 217 alone or in combination with the CMA 218 and/or the mobile core network 212 may identify one or more other MEC suites that may serve as suitable alternates to the first MEC suite 206a. Suitability may be determined according to any number of variables, such as physical proximity, signal, message and/or propagation delay, bandwidth, capacity, and so on. According to the example network slice O&M system 200, the second MEC suite 206b may be considered as candidate resources to service any portion of the service request that may not be serviceable by the first MEC suite 206a.

To the extent that the UE 204 is attached to the first mobile communication transceiver 202a, it is understood that the resources of the first MEC suite 206a may be accessed by the UE 204 vial the first mobile communication transceiver 202a. To the extent that the resources of the second MEC suite 206a will be utilized, it is understood that such resources may be accessed via a backhaul, mid haul and/or fronthaul 214 as may be in place between the first and second mobile communication transceivers 202a. 202b. In at least some embodiments, the example fronthaul 214 may support an X2 interface that may be used to provide the first mobile communication transceiver 202a with access to resources of the second MEC suite 206b. Likewise, the X2 interface may provide the second mobile communication transceiver 202b with access to resources of the first MEC suite 206a. To the extent that the UE 204 is in communication with both mobile communication transceivers 202a, 202b, as may be the case when the UE engages the mobile network according to a multi connectivity (MC) scenario. In such instances, the UE 204 may access resources of the second MEC suite 206b via the second mobile communication transceiver 202b, without necessarily having to utilize the X2 interface.

In at least some embodiments, the orchestration module 216 may obtain numbers and/or types of instantiated VMs and/or VFs and/or network slices, e.g., including current information and/or historical information, and the like. The orchestration module 216 may obtain at least some of the aforementioned information from one or more of the slice manager module 217 and/or the CMA 218. For example, the slice manager module 217 may maintain records identifying resources of the MEC suites 206, configurations of those resources, e.g., network slices, possibly maintenance records as may have been generated during operations of the slice manager module 217, and so on. Alternatively, or in addition, the CMA 218 may monitor one or more parameters of the MEC suites 206 and/or any VMs, NFs and/or network slices 210 hosted thereon. Monitored information may include, without limitation, resource configuration information, state and/or status information, utilization, capacity, reliability, errors, and so on.

The MEC suite may be located at an edge of a network that is relatively close to equipment of the mobile consumer. For example, edges of a mobile cellular network may include one or more radio equipment suites that may include an antenna portion, a radio frequency (RF) portion, and/or a transceiver portion, e.g., a base transceiver station (BTS), a NodeB, an enhanced NodeB (eNB), a gNodeB (gNB). Alternatively, or in addition, the edges of a mobile cellular network may include a wireless access point (WAP). The WAP may be configured to operate in one or more frequency bands, and/or according to one or more wireless protocols. For example, the WAP may operate according to a wireless LAN protocol, e.g., WiFi, BlueTooth, and the like.

The radio equipment suites may include an antenna and/or a tower configured to provide coverage over a particular frequency range and within a particular cellular region, sector or cell. The cells may be differentiated according to power and/or range limitations, e.g., according to macro cells and/or small cells, sometimes referred to as microcells, picocells and/or femtocells. Without limitation, the cells may operate in licensed frequency spectrum, unlicensed frequency spectrum or some combination of both. It is understood that at least some configurations, network operator equipment supporting a cell may include an antenna and/or RF portion, sometimes referred to as a remote radio head (RRH) or a remote radio unit (RRU). The RF portion may be in communication with a transceiver portion that may be collocated with the RF portion and/or at some other remote region that is within a general vicinity of the RF portion.

It is understood that in at least some embodiments a MEC equipment suite may be collocated with the RF equipment, with the base transceiver station, and/or at some other location. To the extent the MEC equipment suite is provided separate from the base transceiver equipment, it is understood that certain restrictions may be imposed on remote locations, such as geographical separation, line of sight delay, signal routing delay. It is envisioned that the MEC equipment suite may be provisioned at a convenient location, such as a nearby equipment cabinet and/or closet. It is envisioned further that one MEC equipment suite may support network slicing at one or more base transceiver stations, e.g., presuming that physical separation, signal and/or propagation delay restrictions are satisfied.

The service may include, without limitation, voice, text, web browsing, email, streaming media and so on. It is understood that the service is preferably delivered according to a service level requirement (SLR), as may be identified in a service level agreement (SLA), e.g., between a network operator and a service provider, between the service provider and the mobile consumer, and/or between the network operator and the mobile consumer. Any particular features of the SLR may vary according to one or more of a type of service, a type and/or feature of the UE, a type of mobile subscriber, a level of subscription, a network conditions, e.g., bandwidth, capacity, power level, interference, error rate, reliability, and so on.

By way of example, types and/or features of the UE may include, without limitation, a display size and/or resolution, an operating band, power, sensitivity, number and/or type of onboard mobile radio, battery level. By way of further example, types of mobile consumers may include an individual consumer, a business consumer, a medical professional consumer, a public safety consumer, a military consumer, a mobile network operator technician, and so on. Alternatively, or in addition, types of mobile consumers may include devices or things as may access services according to a machine-to-machine and/or Internet of Things (IoT) scenario.

In some scenarios, the first MEC suite 206a may be insufficient and/or unavailable to support delivery of service to the UE 204. In such instances, one or more of the orchestration module 216, the slice manager module 217 and/or the CMA 218 may evaluate another MEC suite, such as the second MEC suite 206b. To the extent that neither the first MEC suite 206a, nor the second MEC suite 206b are available, the one or more of the orchestration module 216, the slice manager module 217 and/or the CMA 218 may conclude that a transportable MEC suite 220 should be deployed to a physical location suitable to permit the transportable MEC suite 220 to support delivery of a mobile service to the UE 204.

In some embodiments, the transportable MEC suite 220 may be configurable to provide one or more VMs, VFs and/or network slices as may be required to deliver the mobile service. One or more of the orchestration module 216, the slice manager module 217 and/or the CMA 218 may facilitate identification of available physical resources 222 of the transportable MEC suite 220, configuration of the physical resources 220 as may be necessary to provide the VMs, VFs and/or network slices, a monitoring of the transportable MEC suite 220, e.g., as may include monitoring of any instantiated VMs, VFs and/or network slices and so on. In at least some embodiments, one or more of the orchestration module 216, the slice manager module 217 and/or the CMA 218 may identify the transportable MEC suite 220, and/or otherwise initiate, facilitate and/or request that the transportable MEC suite 220 be transported to a suitable location to support delivery of the requested service to the UE 204. The transportable MEC suite 220 may be provide as a transportable cabinet and/or palette of equipment as may be moved via a truck, rail, boat and/or air. In at least some embodiments, the transportable MEC suite 220 may be provided at least in part as a truck, a drone and/or a satellite.

It is envisioned that one or more of the second MEC suite 206b and/or the transportable MEC suite 220 may be preconfigured and/or otherwise instantiated in a backup capacity. As such, a preconfigured and/or otherwise instantiated second MEC suite 206b and/or transportable MEC suite 220 may be activated to take on the role of actively supporting delivery of the requested mobile service. In at least some embodiments, one or more of the orchestration module 216, the slice manager module 217 and/or the CMA 218 may employ one or more of a rule, a policy and/or logic to identify and/or otherwise select suitable backup MEC resources. For example, implantation of logic may identify one class of MEC resources, e.g., available ground MEC suites 206a, 206b over transportable MEC suite 220. For example, the logic may consider one or more parameters in identifying a suitable MEC resources. Parameters may include, without limitation, one or more of availability, initialization costs, operational costs, expansion capabilities, capacity, complexity, ownership, and so on.

FIG. 2B is a block diagram illustrating an example, non-limiting embodiment of a network slice O&M system 230 functioning within the communication system 100 of FIG. 1 in accordance with various aspects described herein. The example system 230 includes a core cloud that, among other features, support mobile network functionality. Core functionality may include any combination of 3G, LTE, 5G and beyond. In at least some embodiments, the core functionality supports a separate of control plan and data plane functionality which lends itself to supporting network slicing configurations, in which different end-to-end networks may be instantiated on remotely configurable host machines to deliver a variety of network accessible services according to different service level requirements.

The example core cloud 241 includes a 5G core network 242 supporting at least six remote cell sites, 232a-232f, generally 232. One or more of the remote cell sites 232 may extend wireless voice and/or data services to one or more mobile devices, such as the example UE 234. The example system 230 also utilizes network slicing in combination with edge computing. A first computing resource suite 238a is provided at a first physical location relatively close to the first cell site 232a. The first computing resource suite 238a may provide compute, storage and/or communication services that are remotely configurable, e.g., according to cloud computing techniques. In particular, the example first computing resource suite 238a includes Multi-Access Edge Computing (MEC) cloud 236a configured to move computing of mobile network traffic and/or services from the core cloud 241 to an edge of the network, in this instance close to the first remote cell site 232a, and closer to equipment of the mobile service consumer, e.g., the UE 234. The first MEC cloud 236a may be configured to support one or more virtual machines (VM), virtual functions (VF) and/or network slices 240a. The first MEC cloud 236a may be collocated with equipment of the first cell site 232a and/or at some other nearby location accessible via local communication link.

According to the example system 230, a second MEC cloud 236b is hosted on a second computing resource suite 238b at a physical location at or near the third cell site 232c. The second MEC cloud 236b may be configured to support one or more VMs, VFs and/or network slices 240b. Likewise, a third MEC cloud 236c is hosted on a third computing resource suite 238c at a physical location at or near the fourth cell site 232d, adapted to host slices as may be required.

The core cloud 241 includes an intelligent orchestration module (IOM) 246 configured to orchestrate configurations and/or reconfigurations of network resources, such as the MEC clouds 236a, 236b, 236c, generally 236. The IOM 246 may be configured to determine the configurations and/or reconfigurations according to one or more network services delivered and/or requested by equipment of mobile consumers. For example, the IOM 246 may initiate and/or otherwise direct or orchestrate the instantiation of one or more of the network slices 240a of the first MEC cloud 230. The orchestrated network slices 240a, once instantiated, are configured to deliver an associated network accessible service according to a service level requirement (SLR) as may have been identified in a service level agreement (SLA).

In at least some embodiments, the IOM 246 may be configured as a policy driven IOM 246, e.g., connected to a central artificial intelligence and/or machine learning (AI/ML) system 254. The AI/ML system 254 may generate, train and/or otherwise modify an AI/ML system 254, such as neurons of a neural network. The trained AI/ML system 254 may be trained to support one or more activities of the IOM 246, such as determination of MEC cloud configurations, e.g., VM, VF and/or slice configurations as might be based upon one or more of target services, requesting UE device types, network conditions, priorities, subscription levels, and so on. In at least some embodiments, the AI/ML system 254 may be trained to identify a monitoring strategy as may be implemented to monitor one or more of network conditions, message congestion, capacity, delay, jitter, error rates, SLRs and the like.

In at least some embodiments, the AI/ML system 254 may be part of a distributed AI/ML system that incorporates one or more distributed AI/ML modules, e.g., AI slices 257a, 257b, 257c, generally 257, provided at one or more of the MEC clouds 236. For example, a centralized AI/ML system 254 may generate and/or train an AI model, e.g., a neural network, and distribute at least a portion of the trained AI module to one or more of the distributed AI/ML modules 257. The distributed AI/ML modules 257, in turn, may utilize at least a portion of the trained model locally, without having to add to a network traffic load and/or without the additional round-trim message delay between the MEC cloud 236 to the core cloud 241. It is envisioned that the AI/ML model may be updated periodically, as may be necessary to improve performance and/or adapt to changing network conditions and/or service requirements.

The example system 230 also includes a common MEC agent (CMA) 255 that may be configured on physical resources 256 to support the remote orchestration of MEC resources and related operations to delivery network services according to their respective SLRs. For example, the CMA 255 may be in communication with the MEC clouds 236 and/or the centralized AI/ML system 254, and/or the IOM 246. In at least some embodiments, the CMA 255 may be configured to monitor operation of the MEC clouds 236 and/or the VMs, VFs and/or network slices 240 hosted thereon. It is envisioned that the CMA 255 may be physically located relatively at or nearby to one or more of the MEC clouds 236. The CMA 255 may receive monitoring instructions and/or monitoring requirements, e.g., parameters and/or devices to be monitored, from the IOM 246 and/or from the centralized AI/ML 254. The CMA 255 may be further configured to monitor one or more of the MEC clouds 236 according to the monitoring requirements. In at least some embodiments, the CMA 255 may be provided with logic, rules, and/or policies to respond to the monitoring, e.g., by reconfiguring one or more network slices 240a and/or transitioning service from one MEC cloud 236 to another as may be necessary from time to time in order to maintain the SLR.

According to the illustrative example, the network slices 240 may include RAN slices 240 in communication with the core cloud 241 and/or the CMA 255 and adapted to provides a dynamic self-healing. Namely, a dynamic self-healing of the RAN slices may be accomplished by leveraging integrated 5G MEC slices 240, land MEC clouds 236, a mobile MEC, such as a drone MEC 250, or combinations thereof, together with multi connectivity (MC) towers. In this example, the UE 234 engaging in MC with the first and second cell sites 232a, 232b. The RAN slicing provides an architectural technology to address extremely diversified service demands for future mobile networks.

Self-healing of RAN slices provides services with certain quality requirements, e.g., SLR, by minimizing an impact of mobile network failings. For example, when a Primary RAN Slice (PRS), hosted in a land MEC cloud 236a of a corresponding cell site 232a of an MC pair, e.g., cell sites 232a, 232b, fails and/or does not perform according to SLA, a Backup RAN Slice (BRS) may be configured and/or otherwise instantiated, e.g., by the IOM 246, in another land MEC cloud 236b of another cell site 232b of the MC pair. And if the BRS in the second MEC cloud 236b gets into a failure mode, yet another BRS may be instantiated in the drone-based MEC 250, e.g . . . referred to as a MEC on a Drone (MOD) 250 on demand, by the IOM 246 supporting self-healing. The MOD 250 may be provided by resources on a transportable vehicle 252, such as a truck, a drone, and so on. In this manner, the system 230 provides robust and resilient support to network accessible services in the event of any disaster recovery.

It is understood that in at least some embodiments, a concept referred to as wireless-wireline convergence (WWC) system 258 may be utilized. According to the illustrative example, the UE 234 may be in communication with wireline connectivity, such as ethernet, fiber and/or powerline communications. It is envisioned that in at least some instances, self-healing may be accomplished by delivering at least a portion of network services to the UE, e.g., when unavailable via other means. This configuration may be referred to as triangle connectivity (TC), in which the UE 234 may be connected to a wired line 259 (fiber or power line for example), in addition to MC with one or more cell sites 232a, 232b. The various configurations disclosed herein provides a novel self-healing orchestration approach for network resources including RAN slices, e.g., based on one or more of 5G WWC-MC and integrated MEC-enabled 5G edge with the following scenario described below.

A UE 234 may be configured with a simultaneous connection with two cell sites 233a, 233b according to a 5G MC, or dual connectivity configuration. In at least some instances the MC may be extended to TC by adding a further simultaneous connecting with the wired line 259. Continuing with the illustrative example, the first cell site 232a has a connection with a primary slice 240a contained in a corresponding MEC cloud 236a. Similarly, the second cell site 232b has a connection with backup slice 240b contained in other corresponding MEC cloud 236b. To the extent the backup slice 240b, contained in the MEC cloud 236b of the second cell site 232b, becomes corrupt or unavailable, the system 230 may instantiate the MOD 250. It is understood that the provisioning of the various backup resources may be accomplished automatically and/or dynamically to provide self-healing capabilities.

The distributed AI slice(s) 257 may be instantiated on and/or encapsulated in land and drone MEC-enabled 5G edges, and a central orchestrator (controller) backed by central AI. To this end, the IOM 246 may work in cooperation with one or more of the central AI/ML module 254, the CMA 255 and/or distributed AI slices 257 as may be available. According to the illustrative example, a dynamic orchestration is provided that supports self-healing in collaboration with land MEC-enabled and MEC on Drone (MOD) enabled 5G edge employing MC/dual connectivity. In at least some embodiments, the IOM 246 provides a complimentary role that may be leveraged by any existing end-to-end (E2E) orchestration, with options to incorporate elements of wireline MC (via fiber and powerline).

The disclosed techniques that facilitate dynamic self-healing of RAN slices by leveraging integrated 5G MEC (land MEC and drone MEC), together with MC cell sites or towers. The disclosed system architectures and/or procedures address failure of one or more of virtual network functions, local servers within MEC clouds, communication links, and/or an entire MEC cloud facility, e.g., at a regional level. All such scenarios are under the purview of an intelligent orchestrator that is backed by central AI and 5G edge AI.

Most existing self-healing techniques include coverage area optimization, Signal-to-Interference-plus-Noise-Ratio (SINR) optimization, cell capacity optimization, and spectral efficiency optimization for outage compensation. However, self-healing in burgeoning sliced RAN that provides customized services is vastly different from that in traditional RAN and has been rarely attended. The techniques disclosed herein address that gap. For example, RAN slices may be constructed by mobile network operators by renting a part of the resources from the infrastructure providers to provide customized services. When the network fails, e.g., SBSs malfunction, the deployed radio access network slices can be severely affected or even corrupt. Therefore, self-healing of RAN slice becomes indispensable. The concept of self-healing of RAN Slices (SRANS) includes situations in which mobile network operator repair their RAN slices to restore the function and ensure a particular SLR, e.g., a quality of service (QOS). This approach differs from other resource allocation schemes, e.g., that may define the profits of a resource, such as a RAN slices, only with utility. The disclosed techniques allow for consideration other aspects, such as service revenues, deployment costs, such as resources purchase costs paid to infrastructure providers, and/or reconfiguration costs which is incurred in scheduling users also should be taken account in SRANS.

A network slice 240 may be constructed and/or deployed by instantiating a set of virtual network functions (VNFs) on top of MEC (land and drone) cloud servers for provisioning diverse latency-sensitive/time-critical communication services, e.g., autonomous driving and augmented reality, on demand at a lesser cost and time. However, VNFs, integrated MEC cloud servers, and communication links may be subject to failures due to software bugs, misconfiguration, overloading, hardware faults, cyberattacks, power outage, and natural/man-made disaster, to name a few. Failure of a critical network component disrupts services abruptly and leads to users' dissatisfaction, which may result in revenue loss for the network operators. So, design of a highly resilient 5G communication network is of paramount importance for network operators to ensure high availability and service continuity with improved automation. Beneficially, the various architectures and/or procedures disclosed herein provide self-healing automation adapted to simplify network operations, e.g., by providing a dynamic self-healing capability that utilizes intelligent orchestration, allowing for advanced automation that may be configured according to a reactive and/or predictive approach.

Referring again to the example system 230 of 5G network with six base station nodes 232 and a few MEC cloud facilities 236, which may be activated to provide services to equipment, e.g., the UE 234, of network consumers. The UE 234 may attach to the mobile network through one or more nearby base stations 232 with network slices 240 (primary and backup) being deployed to provide services with high resiliency. To handle failures effectively, primary and backup network slices 240 may be deployed in different MEC clouds 236 during initial provisioning and/or on-demand. According to the illustrative example, three land MECs 236a, 236b, 236c are activated to provide services for the UE 234, preferably having enough excess resources to accommodate future requests. The example MOD 250 may be instantiated on demand, e.g., under the control of the IOM 246.

If one UE 234 is attached to the network through multi-connectivity, as shown, then a primary network slice 240a can be placed in the first MEC cloud 236a, while a backup network slice 240b can be placed in the second MEC cloud 236b, or vice versa, without violating a latency requirement. This may be achieved, because the second MEC cloud 236b may be reached in about 1 msec from the user location of the UE 234, by utilizing the MC. The example MC-based service provisioning not only reduces a number of MEC clouds 236 required to provide services to UE 234 of different users, but also increases throughput by transferring service data to the equipment of the user simultaneously through different interfaces, e.g., using inter-frequency connection of master and secondary base stations, while providing high resiliency.

The example approach leverages features of multi-connectivity, network slicing, and MEC technologies to provide a resilient 5G communication network to continuously provide services even in adversarial conditions. The example approach differs from other solutions focused on handling a single node failure. Assigned backup resources may remain idle until a failure occurs in a primary network slice. The example approach offers a cost-efficient deployment of network slices in a multi-connectivity and MEC-enabled 5G networks such that the deployment strategy provides high resiliency against multiple network component failures, e.g., failure of VNFs, failure of local servers within MEC, failure of communication links, and failure of an entire MEC cloud facility at regional level, while also ensuring that service requirements, e.g., latency, are delivered to equipment of the mobile consumers.

A summary of the message flows is described for a failure scenario according to the example system 230. For example, the IOM 246 may detect failure based on AI/ML providing actionable intelligence, e.g., based on monitored information obtained via the CMA 255. Upon detecting a PRS failure in the first MEC cloud 236a, the IOM 246 may initiate the BRS in the second MEC cloud 236b. In at least some embodiments, this may also be accomplished by and/or in cooperation with the CMA 255.

Should the BRS fail in the second MEC cloud 236b, the IOM 246 may initiate another BRS in the MOD 250. By way of example, the MOD 250 may include a drone 252 with a MEC cloud that may be dispatched near to position in and around the failed MEC cloud 236b. After security authentication, the MOD 250 may be viewed as an extension of the RAN MEC landscape of the example system 230.

Benefits offered by the disclosed techniques include, without limitation, one or more of a dynamic RAN slices self-healing for improved MTTR, QoS and resiliency, Improved reliability, improved operating expenditures, and/or improved customer satisfaction. Additionally, the disclosed techniques pave the way for more advanced RAN slice management, e.g., preventing revenue loss and/or offering a service differentiator.

FIG. 2C is a block diagram illustrating yet another example, non-limiting embodiment of a network slice O&M system 260 functioning within the communication system of FIG. 1 in accordance with various aspects described herein. The example network slice O&M system 260 includes three wireless access terminals 262a, 262b, 262c, generally 262. It is envisioned that at least some of the wireless access terminals 262 may be geographically separated, e.g., providing respective areas of wireless coverage that may or may not overlap. The wireless access terminals 262 may include any system and/or device configured to provide wireless network service to user equipment of mobile consumers, including, but not limited to the various examples disclosed herein. According to the illustrative example, each of the wireless access terminals 262 is in communication with a respective MEC suite 266a, 266b, 266c, generally 266. Each of the MEC suites 266, in turn, may include one or more VMs, VFs and/or network slices 267a, 267b, 267c, generally 267.

The example network slice O&M system 260 further includes a core network, e.g., a 5G core network 263 as may be utilized to provide mobile service, terminating one or more control planes and/or data planes to the wireless access terminals 262. The MEC suites 266 may be in further communication with one or more of an orchestration module 265 and or a slice manager 269. The orchestration module may determine, identify and/or otherwise orchestrate a configuration of one or more of the MEC suites 266 according to one or more of the VMs, the VFs and/or the network slices 267. The orchestration module 265 be in communication with the slice manager 269, which may be adapted to direct, control, monitor and/or otherwise implement an orchestrated configuration of one or more of the MEC suites 266 according to one or more of the VMs, the VFs and/or the network slices 267.

The example network slice O&M system 260 also includes first and second common MEC agents (CMA) 268a, 268b, generally 268. The CMAs 268 may be in communication with one or more of the MEC suites 266. According to the illustrative example, the first CMA 268a is in communication with the first and second MEC suites 266a, 266b. Similarly, the second CME 268b is in communication with the second and third MEC suites 266b, 266c. Each CMA 268 may monitor configuration, state, operation and/or performance of any or all interconnected MEC suites 266.

In at least some embodiments, the CMAs 268 may receive monitoring instructions from the orchestration module 265 and/or the slice manger 269. The CMAs 268 may conduct monitoring of interconnected MEC suites 266 according to the monitoring instructions. In at least some embodiments, the CMAs 268 may apply one or more of a logic, a rule and/or a policy responsive to the monitored information. For example, a policy may instantiate and/or otherwise configure physical resources of the MEC suites 266 to instantiate, decommission and/or otherwise monitor one or more of a VM, a VF and/or a network slice. In at least some embodiments, the CMAs 268 may operate autonomously, semi-autonomously, and/or cooperatively e.g., in cooperation with other CMAs 268, the orchestration module 265 and/or the slice manager 269. In at least some embodiments, one or more of the CMAs 268 may incorporate resources configured to perform analytics and/or to implement AI and/or ML. For example, the CMAs 268 may include an AI engine, e.g., and AI slice, that may be configured to implement a model suitably trained to perform one or more of monitoring, reporting, and/or configuring of the MEC suites 266.

To the extent any of the MEC suites 266 is in communication with more than one CMAs 268, the CMAs 268 may be configured such that one has priority over the other. For example, one CMA 268 may operate, while another CMA 268 remains idle with respect to the redundant connection. In this manner, the idle CMA 268 may serve as a spare and/or an error check with respect to operation of the operational CMA 268.

FIG. 2D is a block diagram illustrating an example, non-limiting embodiment of a machine learning system 270 functioning within the communication system 100 of FIG. 1 and the network slice O&M system 200 (FIG. 2A) in accordance with various aspects described herein. For example, machine learning system 270 can facilitate in whole or in part identification of multiple, geographically diverse edge network resources configurable to host a network slice adapted to provide a network service to equipment of a mobile consumer according to a service level requirement. Alternatively, or in addition, the machine learning system 270 can facilitate configurations and/or arrangements edge network resources according to primary and backup roles in which a backup resource may be preconfigured according to a network slice requirement. Having preconfigured a backup resource this manner, transition from a backup role to a primary role may be performed automatically upon indication of an issue likely to jeopardize delivery of the service according to the service level requirement. In at least some embodiments, the machine learning system 270 can facilitate identification of performance parameters to be monitored, e.g., by one or more of the CMA 188, 218, the slice manager module 187, 217, and/or the orchestration module 186, 216 (FIGS. 1, 2A), to facilitate early detection and/or prediction of possible performance issues, e.g., with a primary and/or backup edge network resources, VMs, VFs and/or network slices hosted thereon.

The example machine learning system 270 includes a data analysis module 271, a training data repository 272, a machine learning model 273 and a recommendation engine 274. The recommendation engine 274 may be adapted to provide a recommended configuration of one or more aspects of an access domain, e.g., a network slice, such as a RAN slice, of a mobile communication system. The recommendation configurations may include, without limitation, a recommended configuration of a network edge resource, e.g., to instantiate a VM to perform a VF and/or to configure a network slice. It is understood that reference to network slices herein may include radio access network (RAN) slices adapted for operation according to a supported service requirement and/or a related SLR, the recommended configuration may include one or more accessible network edge resources, e.g., within some access threshold, such as signal and/or message delay, and/or within some region of wireless coverage as may include equipment of a mobile service consumer requesting and/or accessing a network service according to an SLR.

In at least some embodiments, the recommendation engine 274 may be adapted to provide one or more recommended monitoring parameters. The monitoring parameters may include network characteristic parameters, e.g., bandwidth, delay, jitter, error performance and so on. Alternatively, or in addition, the monitoring parameters may correspond to the SLR, e.g., including metrics attributable to the SLR and/or parameters likely to serve as indicators of the SLR.

The data analysis module 271 may collect data from one or more elements of the communication system, e.g., including, but not limited to, edge resources, transport network resources and/or mobile core networks, which may include identification and/or configuration data from one or more base transceiver stations, data from network provisioning records that may provide equipment types, features, capabilities, locations, configurations, and so forth. Alternatively, or in addition, the data may be collected from operation of the configured VMs, VFs and/or network slices. For example, the edge network resources may be configured according to an evaluation test plan. Once configured, the network may be operated, allowing one or more aspects of the network to be monitored. In such instances, the collected data may include one or more of a configuration of the test plane and associated monitored data, e.g., transmit power gains, antenna configurations, received signal levels, error rates, SNR, Eb/No and the like. In at least some embodiments, the collected data may include ancillary information related to the test, such as time of day, day of week, season, environmental conditions, interference, and so on.

The data analysis may include, without limitation, summarizing results, e.g., whether a tested path supported operation according to a predetermined success criterion, was it reachable. Alternatively, or in addition, the data analysis may include discovery of patterns, organization of the collected data, clustering, and the like, representing data analysis results. The data analysis module 271 may provide one or more elements of the collected and/or the analysis results to a training data repository 272. The training data repository 272, in turn, may store and/or otherwise retain the collected data and/or data analysis results in a retrievable manner. For example, the training data repository 272 may include a matrix of test results and/or a collection of similar matrices according to WDM paths, equipment configurations, and the like. Alternatively, or in addition, the training data repository 272 may store the data in a database system.

The machine learning module 273 may employ one or more machine learning techniques. The machine learning technique(s) may utilize content of the training data repository 272 as training data. For example, certain stored records may identify a network configuration and a result that may include message delay, error rates, and/or summary results as to whether a particular VM, VF and/or network slice was performing according to the SLR. The machine learning module 273 may be adapted to identify an input portion of the stored record, e.g., a system configuration and an output portion, e.g., a result of operating the system according to the particular configuration. The machine learning module 273 may formulate a predicted result based on the configuration. According to a training process, the predicted result may be compared to an actual result contained within the training record. The machine learning model 273 may be adapted based on a result of such comparisons. For example, an agreement of the predicted and actual results may represent positive feedback that the model is functioning properly, whereas a disagreement may represent negative feedback. In at least some embodiments, a difference between the predicted result and the actual result may be calculated and interpreted as an error value. It is understood that one or more adjustable features of the machine learning model 273 may be adapted based on the error value. In at least some embodiments, a training process may continue until a success criterion and/or error criterion is observed below a respective threshold.

In at least some embodiments, the data analysis module 271 may collect and/or analyze data of opportunity as may be gathered during routine operation of the access network. Data collected in such a manner may be utilized in an ongoing training process, e.g., allowing the machine learning model 273 to formulate a prediction based on the routine data collection and comparing predicted results to observed actual results.

Although the above examples describe data collection and model training in a context of configurating and operating network edge resources and/or VMs, VFs and/or network slices hosted thereon, it is understood that system may be applied to other data. For example, the data analysis module 271 may collect data relating to usage of an access network. Usage may include, without limitation, numbers of users supported, frequencies, frequency bands and/or channels utilized for communications with UEs and/or for WDM links, bandwidths, utilization, supported applications, user categories, e.g., average consumers, prioritized users, private network usage as may be supported by the access network. In at least some embodiments, the usage results may be stored along with ancillary information, such as time of day, day of week, physical location, events, including scheduled events, such as sporting events, conferences, and/or unscheduled events, such as storms, wildfires, and/or other civil emergencies.

The data analysis module 271 may analyze the collected data to obtain analysis results. For example, the analysis results may correlate usage patterns with ancillary information, types of users, applications, and the like. The analysis results may be stored, e.g., in the training data repository 272 and used to train a machine learning model, such as the example machine learning model 273. It is understood that in at least some embodiments, the machine learning module 273 may be the same one described above in relation to configuration and/or operation of edge network resources, VMs, VFs and/or network slices hosted thereon. Accordingly, the machine learning module 273 may be trained according to combinations of access edge network resource, VM, VF and/or network slice configuration and performance data as well as utilization and other ancillary information. Training may include using prescribed and/or scripted training data. Alternatively, or in addition, training may include using routine operational data to adapt, enhance and/or otherwise adjust the machine learning training model 275.

FIG. 2F is a block diagram illustrating another example, non-limiting embodiment of a machine learning system 275 functioning within the communication system 100 of FIG. 1, and the network slice O&M system 200 of FIG. 2A in accordance with various aspects described herein. The example machine learning system 275 includes a learning algorithm 276 and a model 277. The model 277 may be initialized, modified, adapted and/or otherwise trained according to the learning algorithm 276. The model 277 receives input data from a data source 279, represented by “x,” and generates a predicted output, represented by “v′.” In at least some instances the data source 279 provides the same input data “x” to an actual system, e.g., a physical system 280, to obtain an actual output “v.” A set of training data may be generated according to a pairing of the actual input and output of the system physical 280, x and v. The training data may be processed by the learning algorithm 276 to obtain learned relationships between the actual and training data. In at least some embodiments, the model 277, may be adapted according to the learned relationships to apply a hypothesis to subsequent input data.

In at least some embodiments, a training process trains the model 277 according to an application of the learning algorithm 276, as may have been derived and/or otherwise configured from the training data. A trained model 277 may receive subsequent data from the data source 279 and provide a predicted output v′ according to hypotheses of the trained model 277. In at least some instances, the same data from the data source 279 may be applied to the physical system 280 to obtain an actual output v. The actual output v may be compared to the predicted output v′ to determine an error. To the extent the predicted and actual outputs agree the model 277 is suitably trained. However, to the extent the predicted and actual output disagree, the model 277 may require further training. In at least some embodiments, a tolerable error rate may be established as a threshold value, such that errors below the threshold may initiate further training, whereas errors above the threshold may not. Example error thresholds may be established according to an application, a particular access network, a network operator criterion, a customer criterion and so on. For example, an error threshold may be set at a percentage value, e.g., 80% or 90% success vs. 20% or 10% errors, such that a training process may be continued and/or otherwise initiated until the errors fall below the threshold.

It is understood that in at least some embodiments, the learning algorithm 276 may be adjustable via one or more hyper parameters 278. The hyper parameters 278 may be provide and/or otherwise modified responsive to an observed error rate. It is understood further that the training process may be performed once, e.g., during a system configuration period, periodically, e.g., responsive to an event, such as a system failure and/or reconfiguration, according to a schedule, e.g., periodically, such as hourly, daily, weekly, and so on. In at least some embodiments, the performance operation and/or training process may be performed in a substantially continuous manner, such that predictions provided by the model 277, may be implemented within the physical system 280 to obtain actual results that may be compared with predicted results as described above.

FIG. 2F depicts an illustrative embodiment of a network slice O&M process 281 in accordance with various aspects described herein. For example, the process 281 can facilitate in whole or in part identification of multiple, geographically diverse edge network resources configurable to host a network slice adapted to provide a network service to equipment of a mobile consumer according to a service level requirement. The edge network resources may be arranged according to primary and backup roles in which a backup resource may be preconfigured according to a network slice requirement. Having preconfigured a backup resource this manner, transition from a backup role to a primary role may be performed automatically upon indication of an issue likely to jeopardize delivery of the service according to the service level requirement. In at least some instances the process may be extended by identifying other edge network resources able to host the network slice, possibly including mobile edge network resources that may be deployed and preconfigured in a like manner to serve as a second level of backup.

According to the example process 281 a first network edge resource, e.g., a first multi-access edge computing (MEC) suite, is identified at 282. The first MEC equipment suite may include remotely configurable resources suitable for hosting a primary network slice (PNS) configured to provide a service to user equipment (UE) of a mobile consumer. Example services include any of those generally known to be wireless accessible, including without limitation the various examples provided herein.

According to the example process 281, a second edge resource, e.g., a second MEC suite is identified at 283. The second MEC suite may include remotely configurable resources suitable for hosting a first backup network slice (BNS) capable of providing service to UE according to SLR. The first BNS may be remotely configured on second MEC suite at 284. Remote configuration may include instantiation of one or more VMs, VFs and/or network slices as may be necessary to provide the service to the UE according to the SLR. In at least some embodiments, the second MEC suite is geographically separated from the first MEC suite. For example, the first MEC suite may be locate at or near a first cell base station or tower, whereas the second MEC may be located at or near a second cell base station or tower. Although the towers may be geographically separated, in at least some embodiments they may provide at least a partially overlapping wireless coverage, such that the UE may be configured with and/or otherwise attached to both towers and/or base stations, e.g., according to a multi-connectivity scheme.

Monitoring information, such as one or more rules, parameters and/or guidelines, may be determined, identified and/or otherwise provided, e.g., to a performance monitor at 285. In at least some embodiments, the monitoring information is determined according to delivery of the service to the UE via the PNS according to SLR. It is envisioned that in at least some embodiments, the monitoring information may be prescribed, e.g., by a network operator. Alternatively, or in addition, the monitoring information may be determined according to one or more of analytics, artificial intelligence (AI) and/or machine learning (ML). Such analytical and/or AI/ML approaches may identify and/or rank order the most relevant parameters to monitor according to one or more of a level and/or type of service and/or according to an associated SLR.

According to the process 281, a determination may be made at 286 as to whether a satisfactory level of performance has been achieved. The determination may be based purely on performance data obtained according to the monitoring information identified at 285. Alternatively, or in addition, the determination may be based on other information, such as user feedback. To the extent a satisfactory level of performance has been determined at 286, the process 281 continues from step 285, by providing, updating and/or confirming monitoring guidelines regarding delivery of the service via the PNS according to the SLR. Alternatively, or in addition, the process 281 may continue by monitoring according to previously determined monitoring information, without necessary changing and/or modifying the monitored information. To the extent a satisfactory level of performance may not have been determined at 286, the process 281 proceeds to transition service-related operations from the PNS to the first BNS, such that delivery of the service may continue according to SLR utilizing the first BNS at 287.

In at least some embodiments, a third edge resource, e.g., a third MEC suite may be identified at 288. The third MEC suite may include remotely configurable resources suitable for hosting a second BNS capable of providing service to UE according to SLR. The second BNS may be remotely configure on the third MEC suite at 289. Remote configuration may include instantiation of one or more VMs, VFs and/or network slices as may be necessary to provide the service to the UE according to the SLR. In at least some embodiments, the third MEC suite is geographically separated from the first and second MEC suites. For example, the first and second MEC suites may be locate at or near a first and second cell base stations or towers, whereas the third MEC may be located at or near a third cell base station or tower.

In at least some embodiments, the third MEC suite may be deployable to a target geographic location or region based on need. For example, the third MEC suite may be configured as a mobile system that may be transported and/or otherwise controlled to the target location. Example mobile MEC suites include, without limitation, MEC suite on a palette, suitable for shipping to the target location. Alternatively, or in addition, a mobile MEC suite may include MEC resources on a vehicle, such as a truck, a train, an airplane and/or a boat. Other suitable mobile MEC platforms may include robots, drones and/or satellites.

Monitoring information, such as one or more rules, parameters and/or guidelines, may be determined, identified and/or otherwise provided, e.g., to a performance monitor at 290. In some embodiments, the monitoring information determined at 285 may be utilized is previously determined. Alternatively, or in addition, the monitoring information obtained at 285 may be modified, as may be necessary, e.g., based on a requirement and/or capability of the mobile MEC suite.

According to the process 281, a determination may be made at 291 as to whether a satisfactory level of performance has been achieved. The determination may be based purely on performance data obtained according to the monitoring information identified at 290. Alternatively, or in addition, the determination may be based on other information, such as user feedback. To the extent a satisfactory level of performance has been determined at 291, the process 281 continues from step 290, by providing, updating and/or confirming monitoring guidelines regarding delivery of the service via the first BNS according to the SLR. Alternatively, or in addition, the process 281 may continue by monitoring according to previously determined monitoring information, without necessary changing and/or modifying the monitored information. To the extent a satisfactory level of performance may not have been determined at 291, the process 281 proceeds to transition service-related operations from the first BNS to the second BNS, such that delivery of the service may continue according to SLR utilizing the second BNS at 292.

FIG. 2G depicts an illustrative embodiment of another network slice O&M process 300 in accordance with various aspects described herein. For example, the process 300 can facilitate in whole or in part identification of multiple, geographically diverse edge network resources configurable to host a network slice adapted to provide a network service to equipment of a mobile consumer according to a service level requirement. The edge network resources may be arranged according to primary and backup roles in which a backup resource may be preconfigured according to a network slice requirement. Having preconfigured a backup resource this manner, transition from a backup role to a primary role may be performed automatically upon indication of an issue likely to jeopardize delivery of the service according to the service level requirement. In at least some instances the process may be extended by identifying other edge network resources able to host the network slice, possibly including mobile edge network resources that may be deployed and preconfigured in a like manner to serve as a second level of backup.

According to the example process 300, network slice monitoring guidance is received at 301. The monitoring guidance may include one or more rules, parameters and/or guidelines, may be determined, identified and/or otherwise provided. In at least some embodiments, the monitoring guidance may relate to delivery of the service to the UE via a PNS according to a corresponding SLR. It is envisioned that in at least some embodiments, the monitoring information may be prescribed, e.g., by a network operator. Alternatively, or in addition, the monitoring information may be determined according to one or more of analytics, artificial intelligence (AI) and/or machine learning (ML). Such analytical and/or AI/ML approaches may identify and/or rank order the most relevant parameters to monitor according to one or more of a level and/or type of service and/or according to an associated SLR.

According to the example process 300 a first network edge resource, e.g., a first multi-access edge computing (MEC) suite, is identified at 302. The first MEC equipment suite may include remotely configurable resources suitable for hosting a primary network slice configured to provide a service to user equipment (UE) of a mobile consumer. Example services include any of those generally known to be wireless accessible, including without limitation the various examples provided herein.

According to the example process 300, a second edge resource, e.g., a second MEC suite is identified at 303. The second MEC suite may include remotely configurable resources suitable for hosting a first backup network slice (BNS) capable of providing service to UE according to SLR. The first BNS may be remotely configured on second MEC suite. Remote configuration may include instantiation of one or more VMs, VFs and/or network slices as may be necessary to provide the service to the UE according to the SLR. In at least some embodiments, the second MEC suite is geographically separated from the first MEC suite. For example, the first MEC suite may be locate at or near a first cell base station or tower, whereas the second MEC may be located at or near a second cell base station or tower. Although the towers may be geographically separated, in at least some embodiments they may provide at least a partially overlapping wireless coverage, such that the UE may be configured with and/or otherwise attached to both towers and/or base stations, e.g., according to a multi-connectivity scheme.

Delivery of the service via the PNS according to SLR may be monitored at 304. Monitoring information, such as one or more rules, parameters and/or guidelines, may be determined, identified and/or otherwise provided, e.g., to a performance monitor at 304. It is envisioned that in at least some embodiments, the monitoring information may be prescribed, e.g., by a network operator. Alternatively, or in addition, the monitoring information may be determined according to one or more of analytics, artificial intelligence (AI) and/or machine learning (ML). Such analytical and/or AI/ML approaches may identify and/or rank order the most relevant parameters to monitor according to one or more of a level and/or type of service and/or according to an associated SLR.

According to the process 300, a determination may be made at 305 as to whether a satisfactory level of performance has been achieved. The determination may be based purely on performance data obtained according to the monitoring performed at 304. Alternatively, or in addition, the determination may be based on other information, such as user feedback. To the extent a satisfactory level of performance has been determined at 305, the process 300 continues from step 304, by a monitoring of the delivery of the service via the PNS according to the SLR. To the extent a satisfactory level of performance may not have been determined at 305, the process 300 proceeds to transition service-related operations from the PNS to the first BNS, such that delivery of the service may continue according to SLR utilizing the first BNS at 306.

In at least some embodiments, a third edge resource, e.g., a third MEC suite may be identified at 307. The third MEC suite may include remotely configurable resources suitable for hosting a second BNS capable of providing service to UE according to SLR. The second BNS may be remotely configure on the third MEC suite. Remote configuration may include instantiation of one or more VMs, VFs and/or network slices as may be necessary to provide the service to the UE according to the SLR. In at least some embodiments, the third MEC suite is geographically separated from the first and second MEC suites. For example, the first and second MEC suites may be locate at or near a first and second cell base stations or towers, whereas the third MEC may be located at or near a third cell base station or tower.

In at least some embodiments, the third MEC suite may be deployable to a target geographic location or region based on need. For example, the third MEC suite may be configured as a mobile system that may be transported and/or otherwise controlled to the target location. Example mobile MEC suites include, without limitation, MEC suite on a palette, suitable for shipping to the target location. Alternatively, or in addition, a mobile MEC suite may include MEC resources on a vehicle, such as a truck, a train, an airplane and/or a boat. Other suitable mobile MEC platforms may include robots, drones and/or satellites.

Monitoring information, such as one or more rules, parameters and/or guidelines, may be determined, identified and/or otherwise performed, e.g., by a performance monitor at 308. In at least some embodiments, previously determined monitoring information may be utilized. Alternatively, or in addition, previously determined monitoring information may be modified, as may be necessary, e.g., based on a requirement and/or capability of the mobile MEC suite.

According to the process 300, a determination may be made at 309 as to whether a satisfactory level of performance has been achieved. The determination may be based purely on performance data obtained according to the monitoring information obtained at 308. Alternatively, or in addition, the determination may be based on other information, such as user feedback. To the extent a satisfactory level of performance has been determined at 309, the process 300 continues from step 308, by continuing to monitor delivery of the service. To the extent a satisfactory level of performance may not have been determined at 309, the process 300 proceeds to transition service-related operations from the first BNS to the second BNS, such that delivery of the service may continue according to SLR utilizing the second BNS at 310.

While for purposes of simplicity of explanation, the respective processes 281,300 are shown and described as a series of blocks in FIGS. 2F and 2G, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

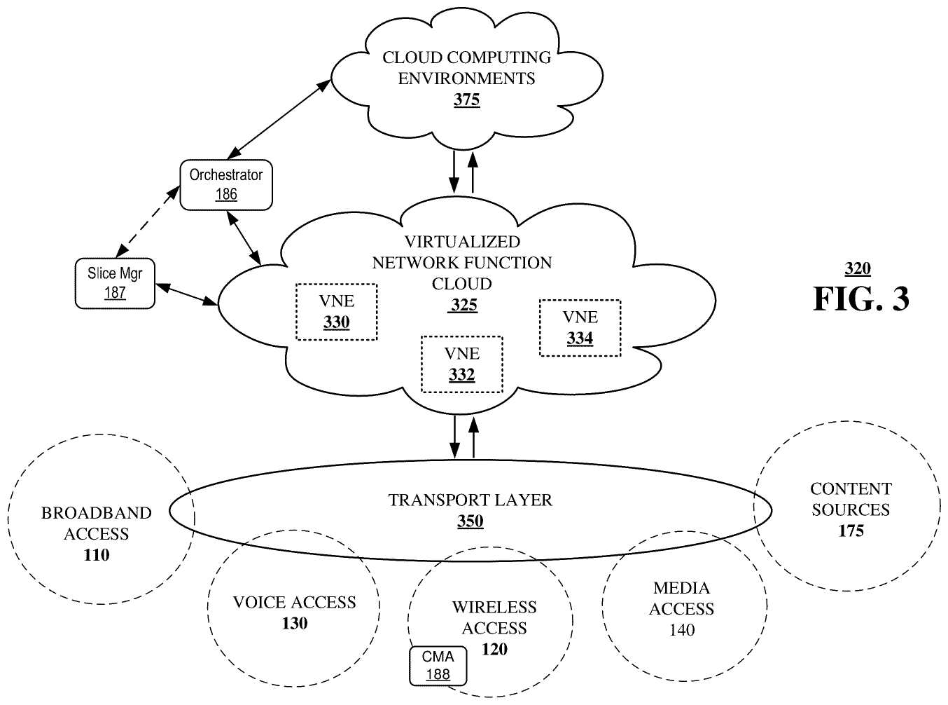

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of communication system 100, the subsystems and functions of system 200, 230, 260, 270, 275, 320 and processes 281, 300 presented in FIGS. 1, 2A, 2B, 2C, 2D, 2E, 2F, 2G and 3. For example, virtualized communication network 320 can facilitate in whole or in part identification of multiple, geographically diverse edge network resources configurable to host a network slice adapted to provide a network service to equipment of a mobile consumer according to a service level requirement. The edge network resources may be arranged according to primary and backup roles in which a backup resource may be preconfigured according to a network slice requirement. Having preconfigured a backup resource this manner, transition from a backup role to a primary role may be performed automatically upon indication of an issue likely to jeopardize delivery of the service according to the service level requirement. In at least some instances the process may be extended by identifying other edge network resources able to host the network slice, possibly including mobile edge network resources that may be deployed and preconfigured in a like manner to serve as a second level of backup.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc., that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure casier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc., to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc., can be instantiated and managed using an orchestration approach similar to those used in cloud compute services.

The cloud computing environments 375 can interface with the virtualized network function cloud 325 via APIs that expose functional capabilities of the VNEs 330, 332, 334, etc., to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

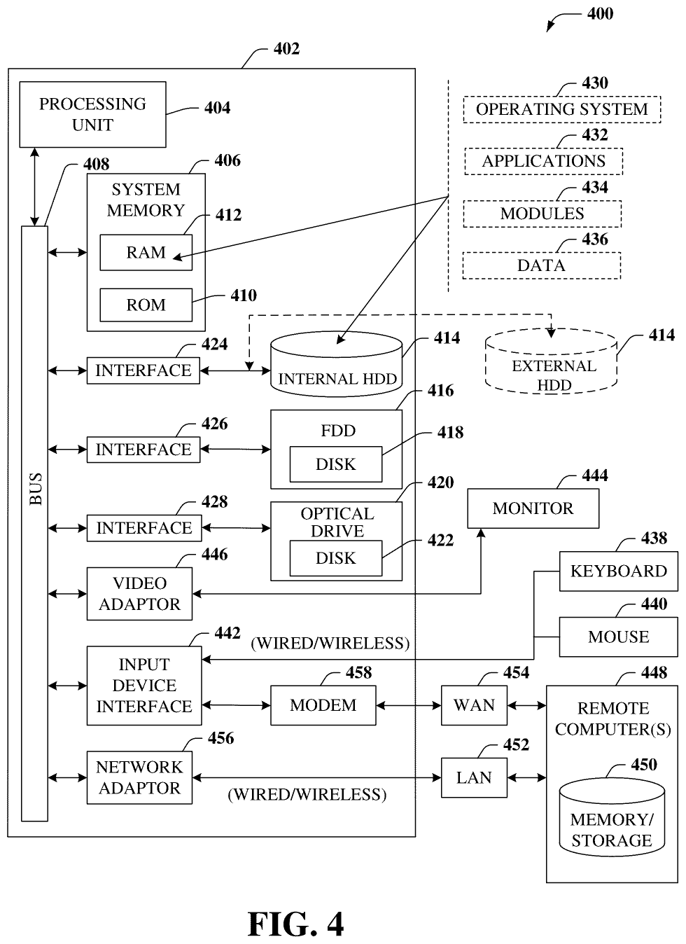

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part identification of multiple, geographically diverse edge network resources configurable to host a network slice adapted to provide a network service to equipment of a mobile consumer according to a service level requirement. The edge network resources may be arranged according to primary and backup roles in which a backup resource may be preconfigured according to a network slice requirement. Having preconfigured a backup resource this manner, transition from a backup role to a primary role may be performed automatically upon indication of an issue likely to jeopardize delivery of the service according to the service level requirement. In at least some instances the process may be extended by identifying other edge network resources able to host the network slice, possibly including mobile edge network resources that may be deployed and preconfigured in a like manner to serve as a second level of backup.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

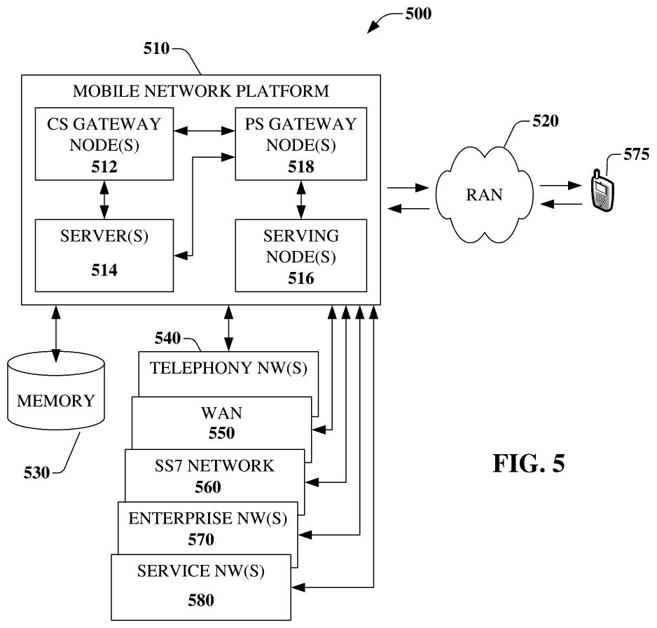

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part identification of multiple, geographically diverse edge network resources configurable to host a network slice adapted to provide a network service to equipment of a mobile consumer according to a service level requirement. The edge network resources may be arranged according to primary and backup roles in which a backup resource may be preconfigured according to a network slice requirement. Having preconfigured a backup resource this manner, transition from a backup role to a primary role may be performed automatically upon indication of an issue likely to jeopardize delivery of the service according to the service level requirement. In at least some instances the process may be extended by identifying other edge network resources able to host the network slice, possibly including mobile edge network resources that may be deployed and preconfigured in a like manner to serve as a second level of backup. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology (ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1 (s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc., that perform particular tasks and/or implement particular abstract data types.

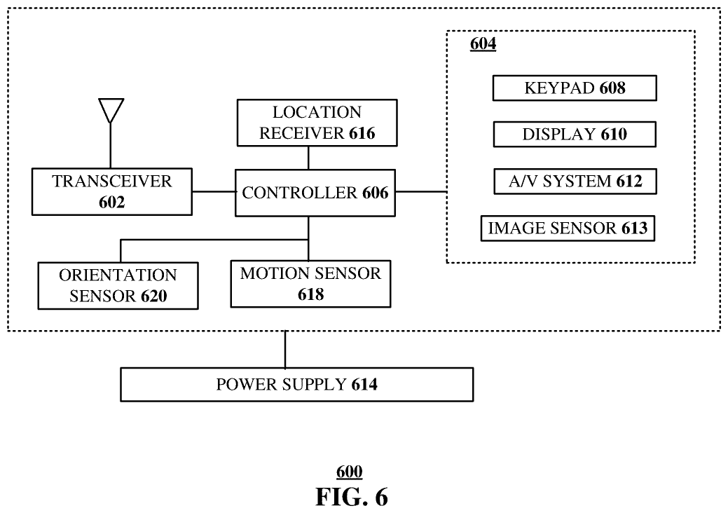

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part identification of multiple, geographically diverse edge network resources configurable to host a network slice adapted to provide a network service to equipment of a mobile consumer according to a service level requirement. The edge network resources may be arranged according to primary and backup roles in which a backup resource may be preconfigured according to a network slice requirement. Having preconfigured a backup resource this manner, transition from a backup role to a primary role may be performed automatically upon indication of an issue likely to jeopardize delivery of the service according to the service level requirement. In at least some instances the process may be extended by identifying other edge network resources able to host the network slice, possibly including mobile edge network resources that may be deployed and preconfigured in a like manner to serve as a second level of backup.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR. LTE, as well as other next generation wireless communication technologies as they arise. The transceiver 602 can also be adapted to support circuit-switched wireline access technologies (such as PSTN), packet-switched wireline access technologies (such as TCP/IP, VOIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human car) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage.” “data store,” data storage,” “database.” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . . xₙ), to a confidence that the input belongs to a class, that is, f (x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component.” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A self-healing network system, comprising:
a processing system including a processor; and
a memory that stores executable instructions that, when executed by the processing system, facilitate performance of operations, the operations comprising:
selecting a first edge network at a first physical location corresponding to an edge of a mobile communications network, wherein the first edge network comprises a compute resource configured according to a requirement of a network slice to obtain a primary network slice, and wherein the primary network slice is adapted to provide a network service to a mobile consumer according to a service level requirement;
associating with the network service a second edge network at a second physical location corresponding to the edge of the mobile communications network and geographically separated from the first physical location, wherein the second edge network comprises a first reserve compute resource available for configuration;
remotely configuring the first reserve compute resource according to the requirement of the network slice to obtain a first backup network slice adapted to provide the network service to equipment of the mobile consumer according to the service level requirement;
monitoring the primary network slice to obtain first monitored performance data;
identifying a first performance issue of the primary network slice according to the first monitored performance data; and
redirecting, responsive to the first performance issue, a providing of the network service from the primary network slice to the first backup network slice.

2. The self-healing network system of claim 1, wherein the operations further comprise:
identifying a performance parameter according to the service level requirement, wherein the monitoring is according to the performance parameter.

3. The self-healing network system of claim 2, wherein the operations further comprise:
providing the performance parameter to a local agent proximal to the edge of the mobile communications network, the local agent monitoring the primary network slice according to the performance parameter to obtain the first monitored performance data.

4. The self-healing network system of claim 1, wherein responsive to the first performance issue, the operations further comprise:
deploying a mobile edge network to a deployed physical location corresponding to the edge of the mobile communications network, wherein the mobile edge network comprises a second reserve compute resource available for configuration;
initiating a remote configuration of the second reserve compute resource according to the requirement of the network slice to obtain a second backup network slice adapted to provide the network service to the equipment of the mobile consumer according to the service level requirement;
monitoring the first backup network slice to obtain second monitored performance data;
identifying a second performance issue of the first backup network slice according to the second monitored performance data; and
redirecting, responsive to the second performance issue, the providing of the network service from the first backup network slice to the second backup network slice.

5. The self-healing network system of claim 4, wherein the mobile edge network comprises a mobile equipment suite and a vehicle adapted to transport the mobile equipment suite.

6. The self-healing network system of claim 5, wherein vehicle comprises a truck, a drone, or a satellite.

7. The self-healing network system of claim 4, wherein the operations further comprise:
determining a message transport delay threshold; and
identifying the deployed physical location according to the message transport delay threshold, wherein message traffic of the network slice does not exceed the message transport delay threshold.

8. The self-healing network system of claim 7, wherein the message traffic comprises control plane message traffic of the mobile communications network, user plane message traffic of the mobile communications network, or a combination of control plane and user plane message traffic of the mobile communications network.

9. The self-healing network system of claim 1, wherein the operations further comprise:
training an artificial intelligence (AI) model according to training data to obtain a trained AI model adapted to identify a network slice performance issue, wherein the training data comprises network slice performance data; and
applying the first monitored performance data to the trained AI model to obtain a predicted performance issue, wherein the identifying the first performance issue is based on the predicted performance issue.

10. The self-healing network system of claim 1, wherein the mobile communications network comprises a mobile cellular communication network.

11. The self-healing network system of claim 10, wherein the mobile cellular communication network comprises a 5G network.

12. A self-healing, networking method, comprising:
identifying, by a processing system including a processor, a first edge network at a first physical location corresponding to an edge of a mobile communications network, wherein the first edge network comprises a compute resource configured according to a requirement of a network slice to obtain a primary network slice, and wherein the primary network slice is adapted to provide a network service to equipment of a mobile consumer according to a service level requirement;
identifying, by the processing system, a second edge network at a second physical location corresponding to the edge of the mobile communications network and geographically separated from the first physical location, wherein the second edge network comprises a first reserve compute resource available for configuration;
initiating, by the processing system, a remote configuration of the first reserve compute resource according to the requirement of the network slice to obtain a first backup network slice adapted to provide the network service to the equipment of the mobile consumer according to the service level requirement;
observing, by the processing system, operation of the primary network slice to obtain first performance data;
detecting, by the processing system, a first performance issue of the primary network slice according to the first performance data; and
redirecting, by the processing system and responsive to the first performance issue, a providing of the network service from the primary network slice to the first backup network slice.

13. The self-healing, networking method of claim 12, wherein responsive to the first performance issue, the method further comprising:
deploying, by the processing system, a mobile edge network to a deployed physical location corresponding to the edge of the mobile communications network, wherein the mobile edge network comprises a second reserve compute resource available for configuration;
initiating, by the processing system, a remote configuration of the second reserve compute resource according to the requirement of the network slice to obtain a second backup network slice adapted to provide the network service to the equipment of the mobile consumer according to the service level requirement;
observing, by the processing system, the first backup network slice to obtain second performance data;
identifying, by the processing system, a second performance issue of the first backup network slice according to the second performance data; and
redirecting, by the processing system and responsive to the second performance issue, the providing of the network service from the first backup network slice to the second backup network slice.

14. The self-healing, networking method of claim 13, wherein the mobile edge network comprises a mobile equipment suite and a vehicle adapted to transport the mobile equipment suite.

15. The self-healing, networking method of claim 12, further comprising:
training, by the processing system, an artificial intelligence (AI) model according to training data to obtain a trained AI model adapted to identify a network slice performance issue, wherein the training data comprises network slice performance data; and
applying, by the processing system, the first performance data to the trained AI model to obtain a predicted performance issue, wherein the identifying the first performance issue is based on the predicted performance issue.

16. The self-healing, networking method of claim 12, wherein the mobile communications network comprises a mobile cellular communication network.

17. The self-healing, networking method of claim 12, wherein the first edge network and the second edge network are in communication with the equipment of the mobile consumer according to a multi-connectivity protocol of the mobile communications network.

18. A non-transitory, machine-readable medium, comprising executable instructions that, when executed by a processing system including a processor, facilitate performance of operations, the operations comprising:
identifying a first edge network at a first physical location corresponding to an edge of a mobile communications network, wherein the first edge network comprises a compute resource configured according to a requirement of a network slice to obtain a primary network slice, and wherein the primary network slice is adapted to provide a network service to equipment of a mobile consumer according to a service level requirement;
identifying a second edge network at a second physical location corresponding to the edge of the mobile communications network and geographically separated from the first physical location, wherein the second edge network comprises a first reserve compute resource available for configuration;
initiating a remote configuration of the first reserve compute resource according to the requirement of the network slice to obtain a first backup network slice adapted to provide the network service to the equipment of the mobile consumer according to the service level requirement;
monitoring operation of the primary network slice to obtain first monitored performance data;
identifying a first performance issue of the primary network slice according to the first monitored performance data; and
reconfiguring, responsive to the first performance issue, a providing of the network service from the primary network slice to the first backup network slice.

19. The non-transitory, machine-readable medium of claim 18, wherein the operations further comprise:
deploying a mobile edge network to a deployed physical location corresponding to the edge of the mobile communications network, wherein the mobile edge network comprises a second reserve compute resource available for configuration;
initiating a remote configuration of the second reserve compute resource according to the requirement of the network slice to obtain a second backup network slice adapted to provide the network service to the equipment of the mobile consumer according to the service level requirement;
observing the first backup network slice to obtain second performance data;
identifying a second performance issue of the first backup network slice according to the second performance data; and
redirecting, by the processing system and responsive to the second performance issue, the providing of the network service from the first backup network slice to the second backup network slice.

20. The non-transitory, machine-readable medium of claim 19, wherein the mobile edge network comprises a mobile equipment suite and a vehicle adapted to transport the mobile equipment suite.
